(19) United States
(12) Patent Application Publication
(10) Pub. No.: US 2016/0148142 A1
(43) Pub. Date: May 26, 2016

(54) MINIMIZING GUEST OPERATING SYSTEM LICENSING COSTS IN A VOLUME BASED LICENSING MODEL IN A VIRTUAL DATACENTER

(71) Applicant: VMWARE, INC., Palo Alto, CA (US)

(72) Inventors: AMARNATH PALAVALLI, Bangalore (IN); KUMAR GAURAV, bANGALORE (IN); T.N Ravi Kumar, Bangalore (IN)

(21) Appl. No.: 14/604,679

(22) Filed: Jan. 24, 2015

(30) Foreign Application Priority Data
Nov. 26, 2014 (IN) 5935/CHE/2014

(51) Int. Cl. G06Q 10/06

(52) U.S. Cl. CPC G06Q 10/06315

(57) ABSTRACT

Techniques for minimizing guest OS licensing costs in a volume based licensing model in a virtual datacenter are described. In one example embodiment, a virtual machine (VM) that requires a license key for a type of guest OS installed in the VM is identified. A license key is then assigned to the VM by first attempting to reassign a license key from an inactive VM, and only if a license key is not available for reassignment, obtaining a new license key for the VM.

### RELATED APPLICATIONS

Benefit is claimed under 35 U.S.C. 119(a)-(d) to Foreign application Serial No. 5935/CHE/2014 filed in India entitled “MINIMIZING GUEST OPERATING SYSTEM LICENSING COSTS IN A VOLUME BASED LICENSING MODEL IN A VIRTUAL DATACENTER”, filed on Nov. 26, 2014, by VMware, Inc., which is herein incorporated in its entirety by reference for all purposes.

### BACKGROUND

For any modern organization acquiring and managing information technology (IT) is a major budgetary concern. Moreover, the local IT hardware in many instances is seldom used at full capacity. So to reduce IT infrastructure costs and waste, instead of acquiring new physical hardware, organizations increasingly are sharing resources by replacing some local computers with virtual machines (VMs). Virtual machines (VMs) are software abstractions of computer hardware that run on a physical host computer system and function as self-contained platforms, running their own operating systems (OSs) and software applications. Each VM has allocated capacity, for example, disk space, processing resources, memory, application software, operating system (OS) and the like and is configured (software stack and licenses) for its intended purpose and expected needs.

Virtualization management software (VMS) may provide a centralized and extensive platform for managing virtual machines within a virtual data center which can be a subset of a physical datacenter and/or span multiple data centers. Virtual data centers typically comprise multiple host computing systems that are managed by the VMS. Virtual machines are often accessed remotely using various remote protocols or systems in order to service or manage applications and/or guest OSs running on them.

Existing techniques place VMs primarily based on provider system optimization, workload predictions and results from continuously monitoring VM resource usage. VM placement is the process of distributing a set of VMs across multiple physical servers. Preferably, the distribution should satisfy a number of above outlined number of different constraints. Under-allocation, wastes resources and energy and reduces the capacity available to other users. Over-allocation impairs the users Quality-of-Service (QoS). Preferably, adequate IT resources are allocated without waste, and while also maintaining the desktop user's QoS. Optimizing VM placement reduces server and overall operational costs of the IT infrastructure costs. One such constraint is a volume licensing of software that makes it easier and more affordable to run software on multiple VMs/computers within an organization. Volume based licensing allows only paying for the software license. Boxed software, on the other hand, includes media (the CD-ROM or DVD), a user's guide and other packaging items. Eliminating these physical costs and purchasing in volume often reduces cost and provides more customized purchasing options and improved software management. Further, when placing the VMs, existing techniques fail to account for such significant constraints/factors that may strongly impact overall IT infrastructure costs.

### SUMMARY

One or more embodiments disclosed herein provide a method for minimizing license costs in conjunction with guest operating system (OS) instances that are licensed using a volume based licensing model in a virtual datacenter. In one aspect, the method includes identifying a virtual machine (VM) that requires a license key for a type of guest OS installed in the VM, and then assigning a license key to the VM by first attempting to reassign a license key from an inactive VM, and only if a license key is not available for reassignment, obtaining a new license key for the VM.

Further embodiments of the present disclosure include a non-transitory computer-readable storage medium that includes instructions that enable a processing unit to implement one or more of the methods set forth above or the functions of the computer system set forth above. In one embodiment, a non-transitory computer-readable storage medium is provided having instructions that manage execution of a virtual machine. The instructions, when executed in a computing device, perform the steps for minimizing guest operating system (OS) licensing costs in a volume based guest OS licensing model in a virtual datacenter.

Embodiments of the present disclosure provide a computer system. The computing system includes multiple host computing systems in a failover cluster in a virtual datacenter. The computing system further includes a network that is communicatively coupled to the multiple host computing systems. Moreover, the computing system includes a management server that is communicatively coupled to the network, wherein the management server includes a virtual management software, which further includes an OS licensing and optimizing module and each of the multiple host computing systems includes an associated failover agent, wherein the guest OS cost optimization module is configured to minimize guest OS licensing costs in a volume based guest OS licensing model in a virtual datacenter.

### BRIEF DESCRIPTION OF THE DRAWINGS

FIG. 1 is a block diagram illustrating system for minimizing guest operating system (OS) licensing costs in a volume based licensing model in a virtual datacenter, according to an example embodiment.

FIG. 2 is a flow diagram of process for minimizing guest OS licensing costs in a volume based licensing model in a virtual datacenter, accordingly to an example embodiment.

FIG. 3 is another flow diagram of process for minimizing guest OS licensing costs in a volume based licensing model in a virtual datacenter, according to an example embodiment.

### DETAILED DESCRIPTION

Embodiments described herein provide a technique for optimizing guest operating system (OS) utilization cost in a volume based guest OS licensing model in a virtual datacenter. The proposed technique minimizes guest OS licensing costs in a volume based licensing environment. Further the technique is based on considering dynamic resource scheduling (DRS)/distributed power management (DPM) for guest OS licensing cost minimization. Furthermore, technique achieves lowest cost and/or best utilization in a volume based guest OS licensing model. Moreover, the technique is applicable to achieve lowest cost and/or best utilization in the volume based guest OS licensing model during initial VM placement, automated VM placement, such as DRS/DPM, and/or manual VM placement and allocation. In addition, the technique achieves cost optimization by reusing/reassigning guest OS licenses already assigned to the powered off and/or idle VMs in the datacenter as the used guest OS license count only increases when a VM is provisioned/powered on.

The terms “placing” and “provisioning” are used interchangeably throughout the document.

### System Overview and Examples of Operation

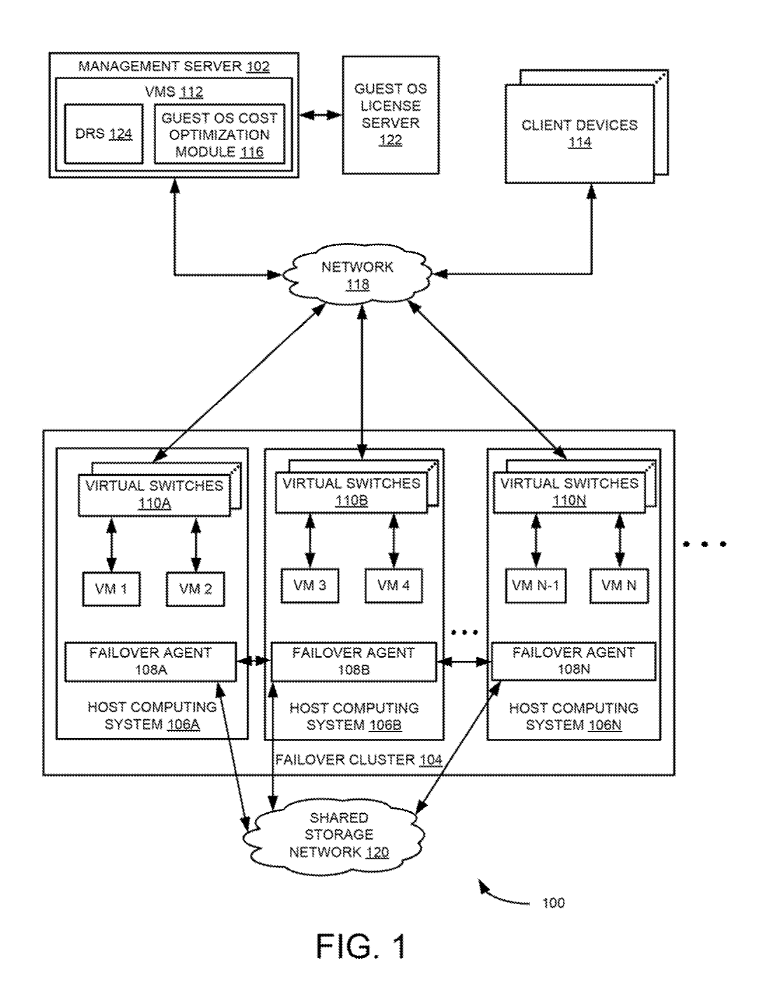

FIG. 1 is a block diagram illustrating system for optimizing guest operating system (OS) utilization cost in a volume based licensing model in virtual datacenter 100, according to an example embodiment. As shown in FIG. 1, system 100 includes multiple host computing systems 106A-N and associated virtual machines (VMs) VM1-N hosted by multiple host computing systems 106A-N in a failover cluster 104. Also as shown in FIG. 1, system 100 includes management server 102 that is communicatively coupled to multiple host computing systems 106B-N via network 118 via associated virtual switches 110 A-N. Further as shown in FIG. 1, management server 102 includes virtual management software (VMS) 112, which in turn includes guest OS cost optimization module 116. Furthermore as shown in FIG. 1, multiple host computing systems 106A-N include associated failover agents 108A-N. In addition, as shown in FIG. 1, network 118 is communicatively coupled to client devices 114. Also as shown in FIG. 1, each of multiple host computing systems 106 A-N is connected to the shared storage network 120. Further as shown in FIG. 1, manager server 102 is coupled to a guest OS license server 122, such as Microsoft Key Management Server (KMS).

In operation, guest OS cost optimization module 116 identifies a virtual machine (VM) VM VM1 that requires a license key for a type of guest OS installed in the VM. In some embodiments. VMS 112 creates VM VM1 that runs on a type of guest OS. In some embodiments, VMS 112 creates the VM VM1 based on computing resource requirements (for example, compute, network and storage demand requirements) upon receiving a request to place the VM VM1 running a type of guest OS. Exemplary requests to create VM VM1 can come from client devices 114, from dynamic resource scheduler (DRS) 124 during run-time and/or cold migration from client devices 114. Guest OS cost optimization module 116 then installs the type of guest OS on VM VM1 associated with first host computing system 106A in virtual datacenter 100. Guest OS cost optimization module 116 then keeps VM VM1 having the type of guest OS in a powered off mode.

Further in operation, guest OS cost optimization module 116 assigns a license key to the VM by first attempting to reassign a license key from an inactive VM, and only if a license key is not available for reassignment, obtaining a new license key for the VM. In some embodiments, guest OS cost optimization module 116 then places VM VM1 by either reusing the type of guest OS license or using a new instance of the type of guest OS based on availability of powered off VM and/or idle VM in virtual datacenter 100. In some embodiments, guest OS cost optimization module 116 determines whether any one of the other installed VMs VM2-N, running the type of guest OS associated with all host computing systems 106A-N in virtual datacenter 100, is powered off. If there is a powered off VM that runs the type of guest OS in any one of the other installed VMs VM2-N, then guest OS cost optimization module 116 selects the powered off VM. Guest OS cost optimization module 116 then places VM VM1 in virtual datacenter 100 by reusing the guest OS license associated with the selected powered off VM. The guest OS cost optimization module 116 will also erase the guest OS license key in the powered off VM, for example by either registry update in Windows®, or by file update in case of Linux®, or by similar means in other guest OSs.

In some embodiments, if there is no powered off VM that runs the type of guest OS in virtual datacenter 100, then guest OS cost optimization module 116 determines whether any one of other installed VMs VM2-N, that runs the type of guest OS associated with all host computing systems 106 A-N in the virtual datacenter 100, is idle. If there is an idle VM that runs the type of guest OS, then guest OS cost optimization module 116 powers off the idle VM and places VM VM1 in virtual datacenter 100 by reusing the type of guest OS license associated with the powered off idle VM. The guest OS cost optimization module 116 also erases the guest OS license key in the powered off VM, for example by either registry update in Windows®, or by file update in case of Linux®, or by similar means in other guest OSs.

In some embodiments, if there is no powered off VM or idle VM that runs the type of guest OS in virtual datacenter 100, then guest OS cost optimization module 116 requests guest OS license server 122 to assign a new instance of the type of guest OS and places VM VM1 in virtual datacenter 100 using the new instance of the type of guest OS. Further in some embodiments, if there is no powered off VM or idle VM that runs the type of guest OS in virtual datacenter 100, then guest OS cost optimization module 116 updates guest OS license server 122 about using a new instance of the type of guest OS and places VM VM1 in virtual datacenter 100 using the new instance of the type of guest OS. Also, in these embodiments, guest OS cost optimization module 116 powers on the VM VM1 after placing the VM VM1 including the type of guest OS in virtual datacenter 100. The above technique minimizes number of concurrently running VMs of a type of OS flavor, thereby minimizing number of guest OS licenses needed to support the virtual datacenter 100 during operation.

Also, although certain terms are used primarily herein, other terms could be used interchangeably to yield equivalent embodiments and examples. For example, the term “host computing system” may be used interchangeably with “physical host”, “physical machine” or “physical device”. Further for example, it is well-known that equivalent terms in the field of system virtualization or similar or related fields could be substituted for such terms s “physical computer,” “hypervisor,” “virtual machine,” or the like. Further, the terms “virtual computing environment” and “virtual datacenter” are used interchangeably throughout the document. The terms “network failure”, “network connectivity failure”, and “lost network connectivity” are used interchangeably throughout the document.

Numerous specific details are set forth herein, such as data formats and code sequences and the like, in order to provide a thorough understanding of the described techniques. The embodiments described also can be practiced without some of the specific details described herein, or with other specific details, such as changes with respect to the ordering of the logic, different logic, different architectures, or the like. Thus, the scope of the techniques and/or functions described is not limited by the particular order, selection, or decomposition of aspects described with reference to any particular routine, module, component, or the like.

### Example Processes

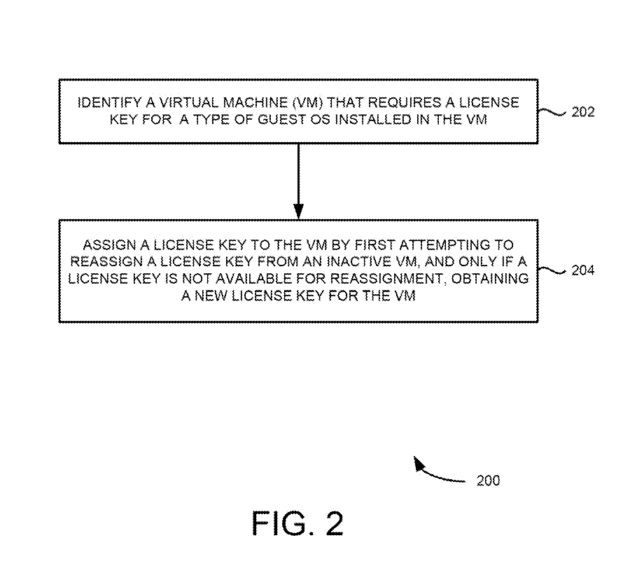

FIG. 2 is a flow diagram of process 200, for providing guest OS utilization cost optimization in a volume based licensing model in a virtual datacenter, according to an example embodiment.

At block 202, process 200 identifies a virtual machine (VM) that requires a license key for a type of guest OS installed in the VM.

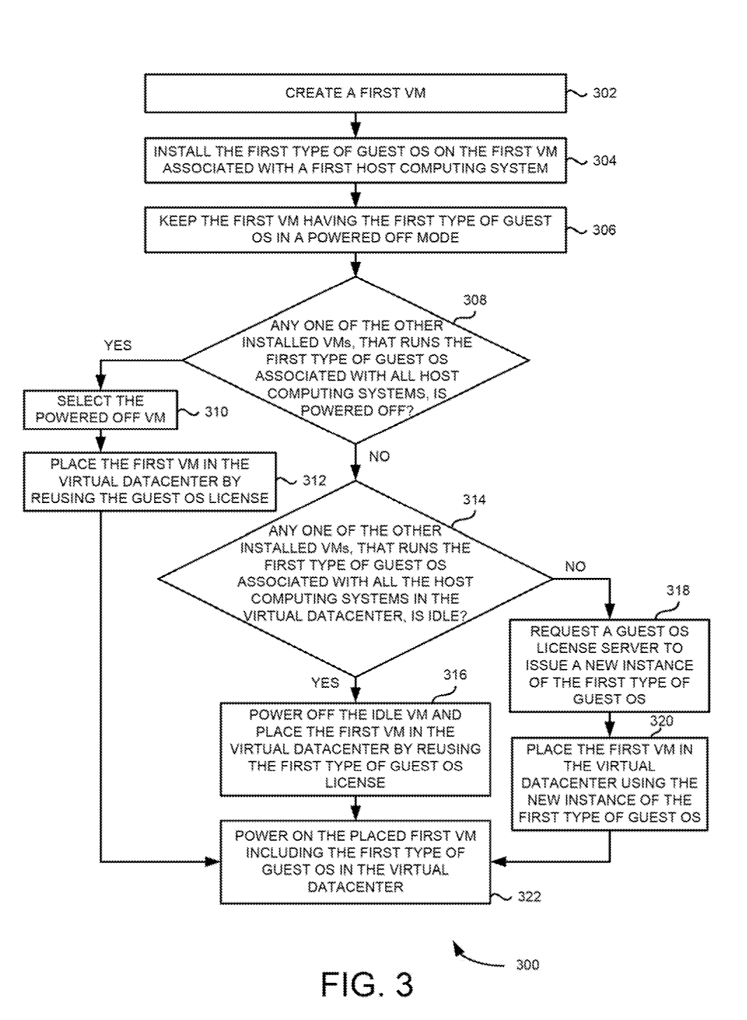

FIG. 3 is another flow diagram of process 300, for providing guest OS utilization cost optimization in a volume based licensing model in a virtual datacenter, according to an example embodiment.

In some embodiments, at block 302, process 300 creates a VM that runs a type of guest OS. At block 304, the type of guest OS is installed on the VM associated with a first host computing system in the virtual datacenter. At block 306, the VM having the type of guest OS is kept in a powered off mode.

At block 204, process 200, shown in FIG. 2, assigns a license key to the VM by first attempting to reassign a license key from an inactive VM, and only if a license key is not available for reassignment, obtains a new license key for the VM.

In some embodiments, at block 308, the VM is placed by either reusing the type of guest OS license or using a new instance of the type of guest OS based on availability of powered off VM and/or idle VM in the virtual datacenter. At block 310, selecting the powered off VM if there is a powered off VM that runs the type of guest OS. At block 312, the VM is placed in the virtual datacenter by reusing the guest OS license associated with the selected powered off VM and goes to block 322. At block 322, the placed first VM, including the type of guest OS is powered on to place in operation in the virtual datacenter.

Further in these embodiments, at block 314, the process 300 determines whether any one of the other installed VMs, that runs the type of guest OS associated with all the host computing systems in the virtual datacenter, is idle if if there is no powered off VM that runs the type of guest OS in the virtual datacenter. At block 316, if there is an idle VM that runs the type of guest OS, then the idle VM is powered-off and then places the VM in the virtual datacenter by reusing the type of guest OS license associated with the powered off idle VM and then goes to block 322. At block 322, the placed first VM, including the type of guest OS is powered on to place in operation in the virtual datacenter.

Furthermore in these embodiments, at block 318, if there is no powered off VM or idle VM that runs the type of guest OS in the virtual datacenter, then the process 300 requests a guest OS license server to issue a new instance of the type of guest OS. At block 320, the VM is placed in the virtual datacenter using the new instance of the type of guest OS and then goes to block 322. At block 322, the placed first VM, including the type of guest OS is powered on to place in operation in the virtual datacenter. At block. 318, if the request to issue a new instance of the first type of guest OS is denied, then the process 300 goes to block 302 and repeats processes outlined in blocks 302 to 322.

Processes 200 and 300, shown in FIGS. 2 and 3, for optimizing guest OS utilization cost in a volume based licensing model in a virtual datacenter is explained in more detail above with reference to the system diagram 100 shown in FIG. 1.

The architecture shown in FIGS. 1-3 may in some embodiments be partially or fully virtualized. For example, system and method 100-300 shown in FIGS. 1-3, respectively, may be one or possibly many VMs executing on physical hardware and managed by a hypervisor, VM monitor, or similar technology. Also, multiple host computing systems 106 A-N shown in FIGS. 1-3 may include virtualization logic to manage multiple VMs.

In an example embodiment, components/modules of VMS 112, guest OS cost optimization module 116 and DRS are implemented using standard programming techniques. In other embodiments. VMS 112 and guest OS cost optimization module 116 may be implemented as instructions processed by a VM that executes as one of other programs.

Furthermore, in some embodiments, some or all of the components of VMS 112, guest OS cost optimization module 116, and DRS may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques.

Even though the above technique is described with reference to guest OS licensing in a volume based licensing model, one can envision that this idea can be applied to any software that is licensed in a volume based licensing model.

Further, from the foregoing it will be appreciated that, although specific embodiments have been described herein for purposes of illustration, various modifications may be made without deviating from the spirit and scope of this disclosure. For example, the methods, techniques, and systems for optimizing guest OS utilization cost in a volume based licensing model in a virtualized datacenter are applicable to other architectures or in other settings. For example, the described techniques may be employed as part of a cloud-based computing resource offering, wherein customers may pay to have higher importance levels associated with their activities, in order to obtain higher levels of service or availability. As another example, the described techniques may be employed to allocate resources or schedule CPU time at the process level within an operating system. Also, the methods, techniques, and systems discussed herein, are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

1. A method for reducing guest operating system (OS) utilization licensing costs in a volume based licensing model in a virtual datacenter, comprising:
identifying a virtual machine (VM) that requires a license key for a type of guest OS installed in the VM; and
assigning a license key to the VM by first attempting to reassign a license key from an inactive VM, and only if a license key is not available for reassignment, obtaining a new license key for the VM.

2. The method of claim 1, further comprising:
creating the VM based on computing resource requirements upon receiving a request to place the VM that runs the type of guest OS;
installing the type of guest OS on the VM associated with a first host computing system in the virtual datacenter; and
keeping the VM having the type of guest OS in a powered off mode.

3. The method of claim 2, wherein assigning a license key to the VM by first attempting to reassign a license key from an inactive VM, and only if a license key is not available for reassignment, obtaining a new license key for the VM, comprises:
determining whether any VM running the type of guest OS and associated with all host computing systems in the virtual datacenter, is powered off;
if there is a powered off VM that runs the type of guest OS, then selecting the powered off VM; and
placing the VM in the virtual datacenter by erasing the guest OS license key in the selected powered off VM and reusing the guest OS license associated with the selected powered off VM.

4. The method of claim 3, further comprising:
if there is no powered off VM that runs the type of guest OS, then determining whether any one of the other installed VMs, that runs the type of guest OS associated with all the host computing systems in the virtual datacenter, is idle; and
if there is an idle VM that runs the type of guest OS, then powering off the idle VM and placing the VM in the virtual datacenter by erasing the guest OS license key in the powered off idle VM and reusing the type of guest OS license associated with the powered off idle VM.

5. The method of claim 4, further comprising:
if there is no powered off VM or idle VM that runs the type of guest OS in the virtual datacenter, then requesting a guest OS license server to issue a new instance of the type of guest OS; and
placing the VM in the virtual datacenter using the new instance of the type of guest OS.

6. The method of claim 5, further comprising:
powering on the placed VM including the type of guest OS in the virtual datacenter.

7. The method of claim 2, wherein receiving the request to place the VM that runs a type of guest OS comprises:
receiving the request to place the VM that runs the type of guest OS in the virtual datacenter upon virtual datacenter startup, from dynamic resource scheduler (DRS) during run-time and/or cold migration.

8. A non-transitory computer-readable storage medium including instructions that are configured, when executed by a computing system, to perform a method for minimizing guest OS licensing costs in a volume based guest operating system (OS) licensing model in a virtual datacenter, the method comprising:
identifying a virtual machine (VM) that requires a license key for a type of guest OS installed in the VM; and
assigning a license key to the VM by first attempting to reassign a license key from an inactive VM, and only if a license key is not available for reassignment, obtaining a new license key for the VM.

9. The non-transitory computer-readable storage medium of claim 8, farther comprising:
creating a VM based on computing resource requirements upon receiving a request to place the VM that runs a type of guest OS;
installing the type of guest OS on the VM associated with a first host computing system in the virtual datacenter;
keeping the VM having the type of guest OS in a powered off mode; and
placing the VM by either reusing the type of guest OS license or using a new instance of the type of guest OS based on availability of powered off VM and/or idle VM in the virtual datacenter.

10. The non-transitory computer-readable storage medium of claim 9, wherein assigning a license key to the VM by first attempting to reassign a license key from an inactive VM, and only if a license key is not available for reassignment, obtaining a new license key for the VM, comprises:
determining whether any one of the other installed VMs, running the type of guest OS associated with all host computing systems in the virtual datacenter, is powered off;
if there is a powered off VM that runs the type of guest OS, then selecting the powered off VM; and
placing the VM in the virtual datacenter by erasing the guest OS license key in the selected powered off VM and reusing the guest OS license associated with the selected powered off VM.

11. The non-transitory computer-readable storage medium of claim 10, further comprising:
if there is no powered off VM that runs the type of guest OS, then determining whether any one of the other installed VMs, that runs the type of guest OS associated with all the host computing systems in the virtual datacenter, is idle; and
if there is an idle VM that runs the type of guest OS, then powering of the idle VM and placing the VM in the virtual datacenter by erasing the guest OS license key in the powered off idle VM and reusing the type of guest OS license associated with the powered off idle VM.

12. The non-transitory computer-readable storage medium of claim 11, further comprising:
if there is no powered off VM or idle VM that runs the type of guest OS in the virtual datacenter, then requesting a guest OS license server to assign a new instance of the type of guest OS; and
placing the VM in the virtual datacenter using the new instance of the type of guest OS.

13. The non-transitory computer-readable storage medium of claim 12, further comprising:
powering on the placed VM including the type of guest OS in the virtual datacenter.

14. The non-transitory computer-readable storage medium of claim 9, further comprising:
receiving a request to place the VM that runs the type of guest OS in the virtual datacenter upon virtual datacenter startup, from dynamic resource scheduler (DRS) during run-time and/or cold migration.

15. A computing system for minimizing guest OS licensing costs in a volume based guest operating system (OS) licensing model in a virtual datacenter, the system comprising:
multiple host computing systems, wherein each host computing system hosting multiple VMs;
a guest OS license server; and
a management server communicatively coupled to the multiple host computing systems and the guest OS license server, wherein the management server comprising virtual management software (VMS), and wherein the VMS includes a guest OS cost optimization module, and they are configured to:
identify a virtual machine (VM) that requires a license key for a type of guest OS installed in the VM; and
assign a license key to the VM by first attempting to reassign a license key from an inactive VM, and only if a license key is not available for reassignment, obtaining a new license key for the VM.

16. The computing system of claim 15, further configured to:
create a VM based on computing resource requirements upon receiving a request to place the VM that runs a type of guest OS;
install the type of guest OS on the VM associated with a first host computing system in the virtual datacenter;
keep the VM having the type of guest OS in a powered off mode; and
place the VM by either reusing the type of guest OS license or using a new instance of the type of guest OS based on availability of powered off VM and/or idle VM in the virtual datacenter.

17. The computing system of claim 16, wherein assigning a license key to the VM by first attempting to reassign a license key from an inactive VM, and only if a license key is not available for reassignment, obtaining a new license key for the VM, comprises:
determining whether any one of the other installed VMs, running the type of guest OS associated with all host computing systems in the virtual datacenter, is powered off;
if there is a powered off VM that runs the type of guest OS, then selecting the powered off VM; and
placing the VM in the virtual datacenter by erasing the guest OS license key in the selected powered off VM and reusing the guest OS license associated with the selected powered off VM.

18. The computing system of claim 17, further configured to:
if there is no powered off VM that runs the type of guest OS, then determine whether any one of the other installed VMs, that runs the type of guest OS associated with all the host computing systems in the virtual datacenter, is idle; and
if there is an idle VM that runs the type of guest OS, then power off the idle VM and placing the VM in the virtual datacenter by erasing the guest OS license key in the powered off idle VM and reusing the type of guest OS license associated with the powered off idle VM.

19. The computing system of claim 18, further configured to:
if there is no powered off VM or idle VM that runs the type of guest OS in the virtual datacenter, then request a guest OS license server to assign a new instance of the type of guest OS; and
place the VM in the virtual datacenter using the new instance of the type of guest OS.

20. The computing system of claim 16, further configured to:
power on the placed VM including the type of guest OS in the virtual datacenter.

21. The computing system of claim 16, further configured to:
receive a request to place the VM that runs the type of guest OS in the virtual datacenter upon virtual datacenter startup, from dynamic resource scheduler (DRS) during run-time and/or cold migration.
